(19) United States
(12) Patent Application Publication
(10) Pub. No.: US 2020/0389422 A1
(43) Pub. Date: Dec. 10, 2020

(54) INFORMATION PROCESSING SYSTEM, SERVER, AND NON-TRANSITORY COMPUTER READABLE MEDIUM

(71) Applicant: Juwwa, Inc., Tokyo (JP)

(72) Inventor: Keita Okumura, Shibuya-ku (JP)

(73) Assignee: Juwwa, Inc., Tokyo (JP)

(21) Appl. No.: 16/595,603

(22) Filed: Oct. 8, 2019

Related U.S. Application Data
(63) Continuation of application No. PCT/JP2019/030658, filed on Aug. 5, 2019.

(30) Foreign Application Priority Data
Jun. 6, 2019 (JP) 2019-105770

(51) Int. Cl. H04L 12/58; G06K 19/077; H04W 4/021; G06Q 50/12; G06Q 50/00

(52) U.S. Cl. CPC H04L 51/12; G06K 19/07758; H04L 51/046; G06Q 50/12; G06Q 50/01; H04W 4/021

(57) ABSTRACT

An information processing system that includes an information processing terminal, NFC tag that stores URL information and installation position information, and a server, and the information processing terminal acquires the URL information and the installation position information by reading the NFC tag and transmits terminal position information and the installation position information to the server, and the server determines whether or not the installation position of the NFC tag and the position of the information processing terminal are within a predetermined distance based on the terminal position information and the installation position information transmitted from the information processing terminal, and permits the information processing terminal to use a talk room service only during a predetermined time period in response to determining that the installation position of the NFC tag and the position of the information processing terminal are within the predetermined distance.

### CROSS-REFERENCE TO RELATED APPLICATIONS

This application is a continuation of International Application No. PCT/JP2019/030658, filed Aug. 5, 2019, which claims priority from Japanese Patent Application No. 2019-105770, filed on Jun. 6, 2019, the entire contents of each are incorporated herein by reference.

### TECHNICAL FIELD

The present disclosure relates to an information processing system, an information processing method, and a computer program.

### BACKGROUND

In recent years in which message applications or SNSs have been widely used, it has become common to use such services when a plurality of persons exchange photographs or messages (Patent Literature 1, or the like).

However, IDs of the message applications or SNSs are important personal information, and a large number of persons are hesitant to disclose these IDs to other parties just to exchange temporary photographs or messages.

### CITATION LIST

### Patent Literature

### [Patent Literature 1] Japanese Unexamined Patent Application, First Publication No. 2014-13575

### SUMMARY

The present disclosure provides an information processing system, comprising: an information processing terminal; a near field communication (NFC) tag that stores uniform resource locator (URL) information regarding URL of a server and installation position information regarding an installation position of the NFC tag; and the server on internet, wherein the information processing terminal includes first circuitry configured to: acquire the URL information and the installation position information by reading the NFC tag, and transmit terminal position information regarding a position of the information processing terminal and the acquired installation position information to the server based on the acquired URL information, and the server includes second circuitry configured to: determine whether or not the installation position of the NFC tag and the position of the information processing terminal are within a predetermined distance based on the terminal position information and the installation position information transmitted from the information processing terminal, and permit the information processing terminal to use a talk room service, in which the information processing terminal can communicate, via the server, with one or more other information processing terminals permitted to use the talk room service, only during a predetermined time period in response to determining that the installation position of the NFC tag and the position of the information processing terminal are within the predetermined distance.

### BRIEF DESCRIPTION OF DRAWINGS

FIG. 1 is a system configuration diagram illustrating an example of a configuration of an information processing system according to an embodiment of the present disclosure.

FIG. 2 is an image diagram illustrating an example of a surface of an NFC tag according to the embodiment of the present disclosure.

FIG. 3 is an image diagram illustrating an installation example of an NFC tag according to the embodiment of the present disclosure.

FIG. 4 is an image diagram illustrating an example of a screen in which a specific talk room is displayed according to the embodiment of the present disclosure.

FIG. 5 is an image diagram illustrating an example of a login screen for logging in to a specific talk room according to the embodiment of the present disclosure.

FIG. 6 is an image diagram illustrating an example of a screen for approving a request for joining a specific talk room according to the embodiment of the present disclosure.

FIG. 7 is an image diagram illustrating an example of a screen for approving an invitation to a specific talk room according to the embodiment of the present disclosure.

FIG. 8 is an image diagram illustrating an example of a screen for requesting joining a specific talk room according to the embodiment of the present disclosure.

FIG. 9 is an image diagram illustrating an example of a screen for inviting joining a specific talk room according to the embodiment of the present disclosure.

FIG. 10 is a block diagram illustrating an example of a configuration of the information processing terminal according to the embodiment of the present disclosure.

FIG. 11 is a flowchart illustrating an example of a flow of an information processing method according to the embodiment of the present disclosure.

### DETAILED DESCRIPTION

### Technical Problem

An object of the present disclosure is to provide a technical improvement to solve or alleviate at least some of the problems of the related art described above. Specifically, the object of the present disclosure is to provide an information processing system, an information processing method, and a computer program capable of providing a place in which information can be temporarily exchanged among a specific number of persons, in which it is not necessary for unnecessary personal information to be sent to other parties.

### Solution to Problem

An information processing system according to the present disclosure is an information processing system including an information processing terminal, an NFC tag in which specific URL information and installation position information have been stored, and a server device to which the information processing terminal is able to be connected via the Internet, wherein the information processing terminal acquires the specific URL information and the installation position information by reading the NFC tag, and transmits terminal position information and the installation position information to the server device to which the information processing terminal has been connected on the basis of the specific URL information, and the server device determines whether or not an installation position of the NFC tag and the information processing terminal are within a predetermined distance on the basis of the terminal position information and the installation position information, permits a user who uses the information processing terminal to use a specific talk room when a result of the determination is that the installation position of the NFC tag and the information processing terminal are within a predetermined distance, and manages the user and one or more other users who use other information processing terminals permitted to use the specific talk room by reading the same NFC tag as the NFC tag, or a another NFC tag in which another installation position having a predetermined relationship with the installation position of the NFC tag has been stored, in association with each other only during within a set expiration date.

When the server device permits use of the specific talk room, the server device can request the other user to approve the user to use the specific talk room in a case in which the other user has already started using the specific talk room.

When the server device permits use of the specific talk room, the server device can transmit information on the other user to the user and request the other user to approve the user to use the specific talk room in response to an operation of the user in a case in which the other user has already started using the specific talk room.

When the server device permits the user to use the specific talk room, the server device can transmit information on the other user to the user and transmit an invitation to make a request for use of the specific talk room to the other user in response to an operation of the user in a case in which the other user has not yet started to use the specific talk room.

User information that the user and the other user are able to unilaterally confirm from each other in the specific talk room can be limited to icon images.

The NFC tag can be included in a sheet-like object that is able to be stuck to a target, and a two-dimensional barcode including the specific URL information and the installation position information stored in the NFC tag can be displayed on a surface of the sheet-like object.

The NFC tag can be installed in an installation object associated with a user at a venue of a predetermined event, and the expiration date can be automatically set on the basis of a holding time of the predetermined event.

The server device can limit a talk that can be displayed in the specific talk room to text and a still image.

The NFC tag can be installed in an installation object associated with a user at a predetermined restaurant, and the expiration date can be automatically set on the basis of an initial time when the server device has permitted use of the specific talk room.

The server device can determine an advertisement to be displayed in the specific talk room on the basis of information of a user who is using the specific talk room.

An information processing method of the present disclosure is an information processing method in an information processing system including an information processing terminal, an NFC tag in which specific URL information and installation position information have been stored, and a server device to which the information processing terminal is able to be connected via the Internet, the information processing method causing one or a plurality of computer processors to execute the steps of: acquiring the specific URL information and the installation position information obtained by reading the NFC tag; determining whether or not an installation position of the NFC tag and the information processing terminal are within a predetermined distance on the basis of the terminal position information and the installation position information; permitting a user who uses the information processing terminal to use a specific talk room when a result of the determination is that the installation position of the NFC tag and the information processing terminal are within a predetermined distance; and managing the user and one or more other users who use other information processing terminals permitted to use the specific talk room by reading the same NFC tag as the NFC tag, or a another NFC tag in which another installation position having a predetermined relationship with the installation position of the NFC tag has been stored, in association with each other only during within a set expiration date.

A computer program of the present disclosure is a computer program for realizing an information processing system including an information processing terminal, an NFC tag in which specific URL information and installation position information have been stored, and a server device to which the information processing terminal is able to be connected via the Internet, the computer program causing one or a plurality of computer processors to realize the functions of: acquiring the specific URL information and the installation position information obtained by reading the NFC tag; determining whether or not an installation position of the NFC tag and the information processing terminal are within a predetermined distance on the basis of the terminal position information and the installation position information; permitting a user who uses the information processing terminal to use a specific talk room when a result of the determination is that the installation position of the NFC tag and the information processing terminal are within a predetermined distance; and managing the user and one or more other users who use other information processing terminals permitted to use the specific talk room by reading the same NFC tag as the NFC tag, or a another NFC tag in which another installation position having a predetermined relationship with the installation position of the NFC tag has been stored, in association with each other only during within a set expiration date.

### Advantageous Effects of Disclosure

With the above configuration, it is possible to provide a technical improvement to solve or alleviate at least some of the problems of the related art described above. Specifically, it is possible to provide an information processing system, an information processing method, and a computer program capable of providing a place in which information can be temporarily exchanged among a specified number of persons, in which it is not necessary for unnecessary personal information to be sent to other parties.

### Embodiments

An embodiment of an information processing system of the present disclosure will be described with reference to the drawings.

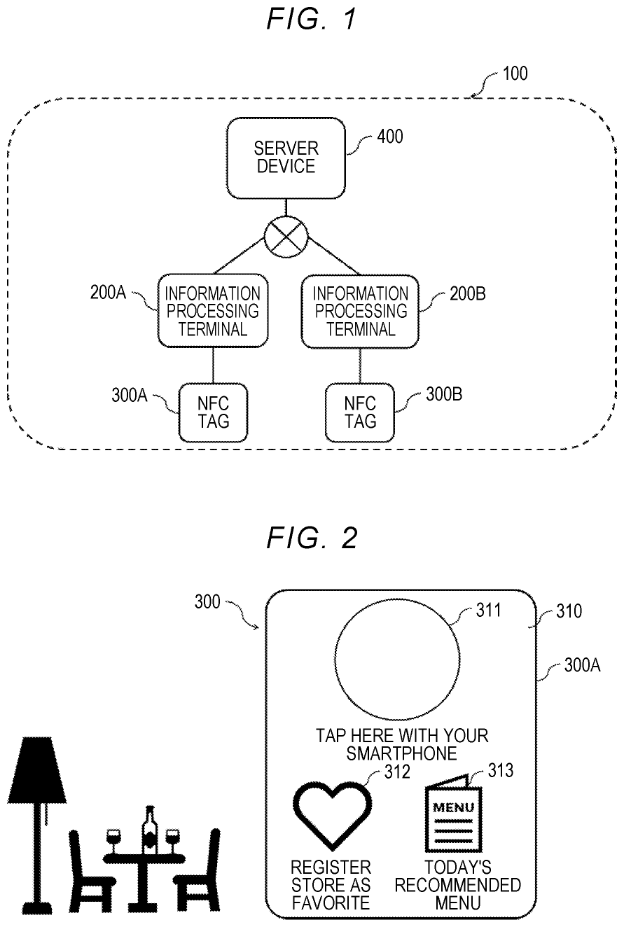

FIG. 1 illustrates an example of an information processing system according to an embodiment of the present disclosure.

As illustrated in FIG. 1, an information processing system 100 according to the present disclosure includes an information processing terminal 200A, an NFC tag 300A, and a server device 400 to which the information processing terminal 200A can be connected via the Internet.

A plurality of information processing terminals can be connected to the server device 400. As an example, FIG. 1 illustrates an example in which two information processing terminals 200A and 200B are connected, but the number of information processing terminals is not limited. In the following description, the information processing terminals will be described as the information processing terminal 200 unless there is a need to specify one information processing terminal.

Further, the information processing system 100 of the present disclosure may include a plurality of NFC tags. In FIG. 1, two NFC tags 300A and 300B are illustrated, but the number of NFC tags is not limited. Hereinafter, the NFC tags may be described as an “NFC tag 300” except when there is no need to specify one NFC tag.

The information processing terminal 200 may be any information processing terminal as long as the information processing terminal can realize functions or methods to be described below. The information processing terminal 200 may include, for example, a smartphone, a mobile phone (a feature phone), a handheld computer device (for example, a personal digital assistant (PDA)), and a wearable terminal (for example, a glasses-type device or a watch-type device), and is assumed to be carried by the user.

Further, application programs for providing various services can be installed in the information processing terminal 200, and the applications according to an instruction of a user can be executed.

It is assumed that the NFC tag 300 stores specific URL information and installation position information. An information processing terminal having an NFC reader function can acquire the information stored in the NFC tag 300 by being brought close to (being held over) or touching the NFC tag 300. NFC (Near Field Communication) means short-range wireless communication.

It can be assumed that the NFC tag 300 can be included in a sheet-like object that can be stuck to a target. Specifically, the NFC tag 300 can be created as an NFC tag seal having a back surface that is a sticking surface and a front surface that is a non-sticking surface.

The target can be a table or chair in a restaurant, or a seat in an event venue for a seminar, sports, or a concert, or the like.

FIG. 2 illustrates a surface 310 of the NFC tag 300 stuck to a table in a restaurant. As an example, a description of a service provided by holding or touching the information processing terminal 200 to the NFC tag 300 can be displayed (printed) on the surface 310.

As an example, a company name or logo 311 of an operating company that provides the information processing system 100 of the present disclosure, a description and an icon 312 indicating that a restaurant can be registered as a favorite in a service that is realized by the information processing system 100 of the present disclosure, and a description and an icon 313 indicating that a menu to be provided by the restaurant can be checked can be displayed on the surface 310 illustrated in FIG. 2.

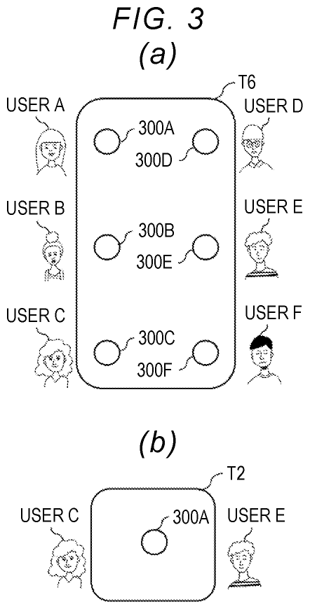

FIG. 3 illustrates a disposition example of NFC tags stuck to the table of the restaurant. FIG. 3(a) illustrates an example in which six NFC tags 300A to 300F are stuck at positions on the table corresponding to respective seats of a six-seat table T6, and FIG. 3(b) illustrates an example in which one NFC tag 300A is stuck at a center position of a two-seat table T2.

The server device 400 may be any server device as long as the server can realize functions or methods to be described below.

The information processing terminal 200 reads the NFC tag 300 to acquire the specific URL information and the installation position information.

In the example illustrated in FIG. 3(a), users A to F hold the information processing terminals 200A to 200F that users A to F use, to the NFC tags A to F stuck in the front of the seats in which users A to F have sat in the table T6. Similarly, in the example illustrated in FIG. 3(b), the user C and the user E hold the information processing terminals 200C and 200E that the user C and the user E use, to the NFC tag A stuck in the front of the seats in which the user C and the user E have sat, in the table T2.

The specific URL information is information that is used for connection to the server device 400. This URL information may be different for each of the NFC tags 300A to 300F or may be common to the NFC tags 300A to 300F managed as the same group.

The installation position information is information indicating a position in which the NFC tag 300 is installed. This installation position information can be, for example, information indicating a position in a store. In this case, it is assumed that the server device 400 stores data indicating a map of installation places (a seat chart in the store).

This installation position information may be different for each of the NFC tags 300A to 300F or may be common to the NFC tags NFC tags 300A to 300F managed as the same group. For example, in the example illustrated in FIG. 3(a), the NFC tags 300A to 300F may store common installation position information, or the NFC tags 300A to 300F may store separate installation position information. In the latter case, the separate installation position information is managed as the same group associated with one table.

The acquisition of the information by the information processing terminal 200 is performed by holding or touching the information processing terminal 200 over or to the NFC tag 300 using the NFC reader function included in the information processing terminal 200. A known scheme can be used as a scheme of acquiring the information of the NFC tag using the NFC reader function.

The information processing terminal 200 transmits terminal position information and the installation position information to the server device 400 to which the information processing terminal 200 has been connected on the basis of the specific URL information.

The server device 400 determines whether an installation position of the NFC tag 300 and the information processing terminal 200 are within a predetermined distance on the basis of the terminal position information and the installation position information.

That is, the server device 400 determines whether or not the information processing terminal 200 is at the installation position of the NFC tag 300 (whether the user is at the installation position). In this case, it is preferable for the predetermined distance to be set appropriately in consideration of accuracy of the position information of the information processing terminal 200 and the installation place of the NFC tag 300.

For example, in the case of a large restaurant in which a large table is disposed in an open space and a sports venue in which crowd seats are crowded, as the installation place, it is preferable for the predetermined distance to be set to be shorter in the venue.

When a result of the determination is that the installation position of the NFC tag 300 and the information processing terminal 200 are within the predetermined distance, the server device 400 permits the user who uses the information processing terminal 200 to use a specific talk room.

It is assumed that the specific talk room refers to a service in which messages can be exchanged between groups consisting of a plurality of users, which the server device 400 provides via the Internet.

The server device 400 manages one or more other users B to F who use the other information processing terminals 200B to 200F permitted to use the specific talk room by reading the other NFC tags 300B to 300F in which other installation positions having a predetermined relationship with the installation position of the NFC tag 300A have been stored, and the user A in association with each other (FIG. 3(a)).

Alternatively, the server device 400 manages the other user C who uses the information processing terminal 200C permitted to use the specific talk room by reading the same NFC tag 300A as the NFC tag 300A and the other user E who uses the information processing terminal 300E in association with each other (FIG. 3(b)).

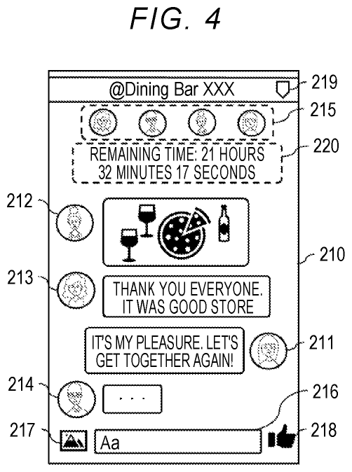

FIG. 4 is a diagram illustrating an example of a specific talk room screen 210 that is displayed on a display screen of the information processing terminal 200A. As illustrated in FIG. 4, users A to D associated with the information processing terminals 200A to 200D can transmit or receive photographs or comments in the specific talk room on the Internet.

In FIG. 4, users A to D are displayed to be identifiable by icon images 211 to 214 in which face photographs or the like have been used. Further, for example, a joining user list 215, a text input field 216, a photograph sticking button 217, a Like button 218 for giving a good evaluation to comments of other users, and a Favorite button 219 for storing a place in which the user is located as a favorite are displayed in the screen 210 illustrated in FIG. 4, but the present disclosure is not limited thereto and various objects can be disposed.

Here, information 220 indicating “remaining time” is displayed in the screen 210 illustrated in FIG. 4. That is, the information processing system 100 according to the present disclosure is characterized in that association between the user and the other user is limited during within a set expiration date.

The expiration date may be, for example, a predetermined time (for example, 24 hours) from a time when the earliest user is permitted to use the talk room. A count start timing of the expiration date is not limited to this example, and may be determined on the basis of a timing when the number of users in the talk room has reached a predetermined number, a timing when an actual time has reached a predetermined time, or the like.

With the above configuration, it is possible to provide a technical improvement to solve or alleviate at least some of the problems of the related art described above. Specifically, it is possible to provide a talk room that is temporarily opened among a specified number of persons, in which it is not necessary for unnecessary personal information to be sent to other parties.

Accordingly, it possible to share information in a talk room that is temporarily opened, in which it is not necessary for an ID of a message application or an SNS which is important personal information to be sent to other parties.

Further, it is possible to cause user A who uses the information processing terminal 200A permitted to use the specific talk room by the server device 400 to perform a process of logging in to a service including a talk room that is realized by the information processing system 100 of the present disclosure before entering the talk room.

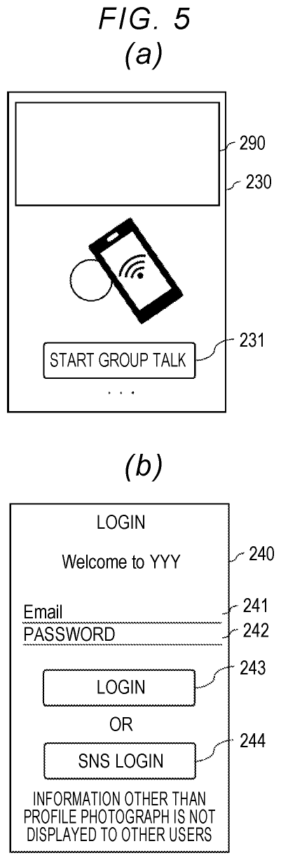

FIG. 5 illustrates a transition of a screen that is displayed in the display screen of the information processing terminal 200A that has been permitted to use the specific talk room by the server device 400. A talk room use start button 231 or the like is displayed in an initial screen 230 illustrated in FIG. 5(a), but the present disclosure is not limited thereto and an advertisement display field 290 or the like may be displayed. The advertisement display field 290 is provided such that it is possible to distribute an advertisement fee according to the number of accesses to restaurants and/or operating companies.

When the use start button 231 is selected by user A, the display screen transitions to a login screen 240 as illustrated in FIG. 5(b). In the login screen 240, an ID input field 241, a password input field 242, and a login button 243 or an SNS login button 244 can be displayed. A login process can be performed using a dedicated ID and password of a service, or can also be performed using an ID and password of an external affiliated SNS. The ID may be a registered mail address.

With the above configuration, since the user who uses the talk room is limited to a user registered as a user of the service, the safety of use of the talk room is improved.

When the server device 400 permits use of the specific talk room, the server device 400 can request the other user to approve the user to use the specific talk room in a case in which the other user has already started using the specific talk room.

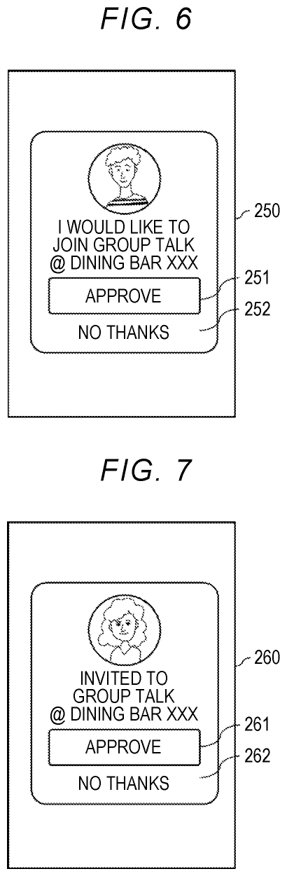

FIG. 6 illustrates an example of an approval screen 250 that is displayed in a display screen of an information processing terminal of another user when a user makes a request for joining a talk group that the other user has already joined. As illustrated in FIG. 6, the other user can approve a user's joining the talk group by selecting a displayed approval button 251. Similarly, the other user can reject the user's joining the talk group by selecting a displayed non-approval button 252.

FIG. 7 illustrates an example of an approval screen 260 that is displayed in the display screen of the information processing terminal of the user when the user is invited to join a talk group from a talk group which another user has already joined. As illustrated in FIG. 7, the user can approve an invitation to a talk group of another user by selecting a displayed approval button 261. Similarly, the user can reject the invitation to the talk group of the other user by selecting a displayed non-approval button 262.

With the above configuration, since each other's approval is required for joining/invitation to the talk group, the safety of use of the talk group is improved.

When the server device 400 permits use of the specific talk room, the server device 400 can transmit the information on the other user to the user and request the other user to approve the user to use the specific talk room in response to an operation of the user in a case in which the other user has already started using the specific talk room.

That is, it is possible to confirm information on the other user before requesting approval from the other user.

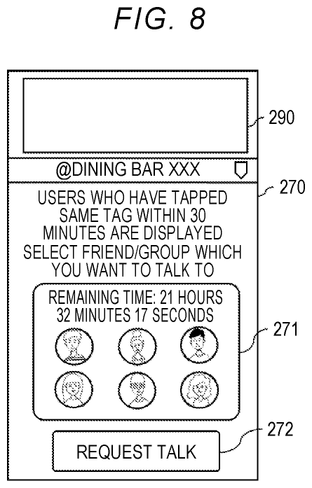

FIG. 8 illustrates an example of a request screen 270 that is displayed in the display screen of the information processing terminal of the user when the user makes a request for joining a talk group that another user has already joined. As illustrated in FIG. 8, the user confirms a displayed group 271, selects a group in which the user wants to join a talk, and selects a talk request button 272, such that the user can request another user who has already joined the group 271 to approve the use of the talk room.

Although only one group is displayed in the request screen 270 illustrated in FIG. 8, a plurality of groups are displayed in a case in which another group is using another talk room using a common NFC tag before an expiration date of a talk room is reached.

With the above configuration, since it is possible to request approval after confirming the information on the other user who joins the displayed group, it is possible to prevent a mistake of making a request for joining a talk room different from that intended by the user.

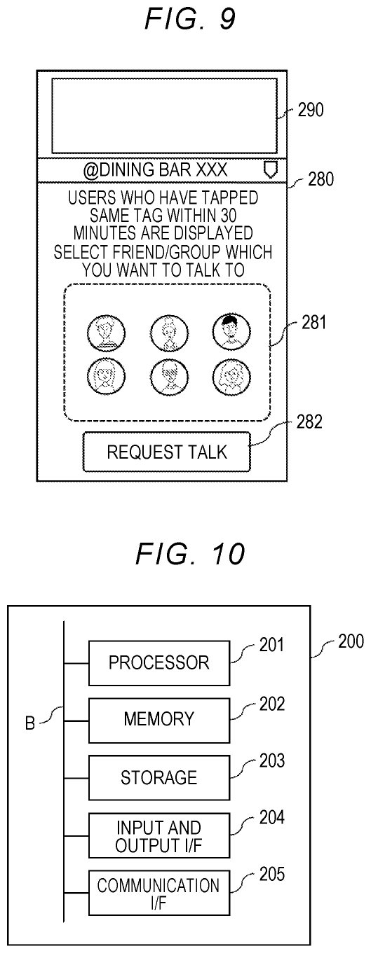

FIG. 9 illustrates an example of a request screen 280 that is displayed in the display screen of the information processing terminal of the user when the user creates a talk room in which other users have not yet participated. As illustrated in FIG. 9, the user confirms a displayed other user 281, selects one or a plurality of other users joining the talk, and selects a talk request button 282 such that an invitation to the talk room can be transmitted to the selected other user.

With the above configuration, it is possible to prevent other users who have an intention different from the user from using the talk room.

Further, it is assumed that user information that user A and other users B to D can unilaterally confirm from each other in the specific talk room is limited to icon images 211 to 214, as illustrated in FIGS. 4, 8, and 9.

As illustrated in FIG. 5, when the SNS login button 244 has been selected in the login screen 240, an icon image used in the SNS is also displayed in the talk room. When the login button 243 has been selected, a pre-registered icon image is displayed in the talk room. The icon image may be changed after login.

With the above configuration, the user and other users can be prevented from making contact using other services through searching using personal information of each other after an expiration date of the talk room has passed.

As described above, the NFC tag 300 can be included in a sheet-like object that can be stuck to a target. A known NFC tag seal may be used as this sheet-like object.

Further, a two-dimensional barcode including the specific URL information and the installation position information stored in the NFC tag 300 can be displayed on a surface of the sheet-like object. A QR code (registered trademark) can be used as an example of the two-dimensional barcode.

With the above configuration, a user who uses an information processing terminal that has no NFC reader function can also use this service.

The NFC tag 300 can be installed in an installation object associated with the user at a venue of a predetermined event.

The predetermined event can be an event such as a seminar, a sporting event, a concert, or a conference. In this case, the user and the other users are persons actually present at a venue of the event. The installation object may be, for example, a seat or a flag when the event is a sporting event, a table when the event is a seminar, or a floor when the event is a concert.

The expiration date in this case can be automatically set on the basis of a hold time of the predetermined event.

Specifically, the expiration date may be determined automatically as the same time by inputting hold time information of an event provided by an organizer, or it is preferable for the expiration date to be automatically extended even when an end time of the hold time has exceeded a scheduled time.

With the above configuration, the talk room can be opened according to the hold time of the event.

It is preferable for the server device 400 to limit a talk that can be displayed in a specific talk room to text and a still image.

This is a useful limitation in the event of the sport involving a right to broadcast moving images. Due to this limitation, it is possible to prevent moving images captured by the user from being posted to the talk room. Alternatively, it is possible to prevent only moving images regarding the event from being posted, using a known image analysis technology.

The NFC tag can be installed on an installation object associated with a user at a predetermined restaurant.

The predetermined restaurant can be, for example, a tavern, or a foot stall. In this case, the user and the other users are persons in the restaurant. The installation object can be a table or chair installed in the restaurant.

In this case, the expiration date can be automatically set on the basis of an initial time when the server device has permitted the use of the specific talk room.

Further, it is preferable for the advertisement display field 290 to be provided in the display screen, as illustrated in FIGS. 5, 8, and 9. The server device 400 can determine an advertisement to be displayed on an advertisement field in the specific talk room on the basis of information of the user who is using the specific talk room.

The information of the user can be information such as nationality, gender, age, or residence. The information of the user may further include religious information or allergy information. By considering such information, it is possible to determine an appropriate advertisement to be displayed to the user.

Further, it is preferable to perform analysis to determine whether or not inappropriate words or images are included in a posting of text comments including pictographs or a posting of images for a specific talk room in advance, and to prevent the inappropriate words or images from being posted. Such analysis can be performed in real time by preparing an NG word database or using a known image analysis technology.

A hardware configuration of the information processing terminal 200 will be described herein with reference to FIG. 10. The information processing terminal 200 includes a processor 201, a memory 202, a storage 203, an input and output interface (an input and output I/F) 204, and a communication interface (communication I/F) 205. The respective components are connected to each other via a bus B.

The information processing terminal 200 realizes functions or methods described in the embodiment in cooperation with the processor 201, the memory 202, the storage 203, the input and output I/F 204, and the communication I/F 205.

The processor 201 executes functions and/or methods that are realized by a code or an instruction included in a program stored in the storage 203. The processor 201 includes, for example, a central processing unit (CPU), a micro processing unit (MPU), a graphics processing unit (GPU), a microprocessor, a processor core, a multiprocessor, an application-specific integrated circuit (ASIC), or a field programmable gate array (FPGA), and each process disclosed in each embodiment can be realized by a logic circuit (hardware) or a dedicated circuit formed of an integrated circuit (an integrated circuit (IC) chip or large scale integration (LSI)). Further, these circuits may be realized by one or a plurality of integrated circuits, and a plurality of processes illustrated in each embodiment may be realized by one integrated circuit. Further, an LSI may also be referred to as a VLSI, a super LSI, an ultra LSI, or the like according to a degree of integration.

The memory 202 temporarily stores the program loaded from the storage 203, and provides a work area to the processor 201. The memory 202 also temporarily stores various pieces of data generated while the processor 201 is executing the program. The memory 202 includes, for example, a random access memory (RAM) and a read only memory (ROM).

The storage 203 stores a program. The storage 203 includes, for example, a hard disk drive (HDD), a solid state drive (SSD), and a flash memory.

The communication I/F 205 is mounted as hardware such as a network adapter, communication software, and a combination thereof, and performs transmission and reception of various pieces of data via a network. The communication may be executed either by wire or wirelessly, or any communication protocol may be used as long as communication can be executed. The communication I/F 205 executes communication with another information processing device via a network. The communication I/F 205 transmits various pieces of data to the other information processing device according to an instruction from the processor 201. Further, the communication I/F 205 receives various pieces of data transmitted from the other information processing device and transfers the data to the processor 201.

The input and output I/F 204 includes an input device that inputs various operations with respect to the information processing terminal 200 and an output device that outputs a processing result of the information processing terminal 200. In the input and output I/F 204, the input device and the output device may be integrated, or the input device and the output device may be separated.

The input device is realized by any one or a combination of all types of devices that can receive an input from a user and transfer information related to the input to the processor 201. The input device includes, for example, a touch panel, a touch display, hardware keys such as a keyboard, or a pointing device such as a mouse.

The output device outputs a processing result of the processor 201. The output device includes, for example, a touch panel, and a speaker. Similarly, the server device 400 can be configured using the hardware configuration of FIG. 9.

Subsequently, the information processing method of the present disclosure will be described with reference to the drawings.

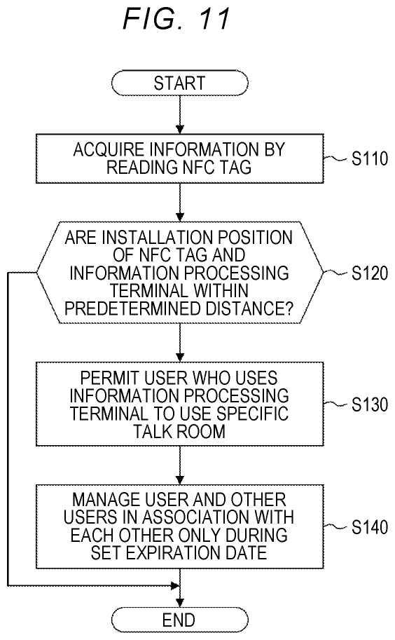

FIG. 11 illustrates an example of a processing flow of the information processing method according to the embodiment of the present disclosure.

The information processing method of the present disclosure is an information processing method in an information processing system including an information processing terminal, an NFC tag in which specific URL information and installation position information have been stored, and a server device to which the information processing terminal can be connected via the Internet, and causes one or a plurality of computer processors to execute the following steps S110 to S140.

In step S110, the specific URL information and the installation position information are acquired by reading the NFC tag.

In step S120, it is determined whether or not the installation position of the NFC tag and the information processing terminal are within the predetermined distance on the basis of the terminal position information and the installation position information.

In step S130, when a result of the determination is that the installation position of the NFC tag and the information processing terminal are within the predetermined distance, the user who uses the information processing terminal is permitted to use the specific talk room.

In step S140, the user and one or more other users who use other information processing terminals permitted to use the specific talk room by reading the same NFC tag as the NFC tag, or a another NFC tag in which another installation position having a predetermined relationship with the installation position of the NFC tag has been stored are managed in association with each other only during within a set expiration date.

With the above configuration, it is possible to provide a technical improvement to solve or alleviate at least some of the problems of the related art described above. Specifically, it is possible to provide a talk room that is temporarily opened among a specified number of persons, in which it is not necessary for unnecessary personal information to be sent to other parties.

Finally, an embodiment of a computer program according to an embodiment of the present disclosure will be described.

The computer program of the present disclosure is a computer program for realizing an information processing system including an information processing terminal, an NFC tag in which specific URL information and installation position information have been stored, and a server device to which the information processing terminal can be connected via the Internet, and causes one or a plurality of computer processors to realize the following functions 510 to 540.

In the function 510, the specific URL information and the installation position information are acquired by reading the NFC tag.

In the function 520, it is determined whether the installation position of the NFC tag and the information processing terminal are within a predetermined distance on the basis of the terminal position information and the installation position information.

In the function 530, when a result of the determination is that the installation position of the NFC tag and the information processing terminal are within the predetermined distance, the user who uses the information processing terminal is permitted to use the specific talk room.

In the function 540, the user and one or more other users who use other information processing terminals permitted to use the specific talk room by reading the same NFC tag as the NFC tag, or a another NFC tag in which another installation position having a predetermined relationship with the installation position of the NFC tag has been stored are managed in association with each other only during within a set expiration date.

With the above configuration, it is possible to provide a technical improvement to solve or alleviate at least some of the problems of the related art described above. Specifically, it is possible to provide a talk room that is temporarily opened among a specified number of persons, in which it is not necessary for unnecessary personal information to be sent to other parties.

Further, an information processing device such as a computer or a mobile phone can be suitably used to function as the server device or the terminal device according to the embodiment described above. Such an information processing device can be realized by storing a program in which processing content for realizing each function of the server device or the terminal device according to the embodiment has been described, in a storage unit of the information processing device, and causing the program to be read and executed by a CPU of the information processing device.

Although several embodiments of the present disclosure have been described, these embodiments are presented as examples and are not intended to limit the scope of the disclosure. These novel embodiments can be implemented in various other forms, and various omissions, replacements, and changes can be made without departing from the scope of the disclosure. These embodiments or modifications thereof are included in the scope or gist of the disclosure, and are included in the disclosures described in the claims and the equivalents thereof.

Further, the schemes described in the embodiments can be stored in, for example, a recording medium such as a magnetic disk (floppy (registered trademark) disk, hard disk, or the like), an optical disc (a CD-ROM, a DVD, an MO, or the like), a semiconductor memory (a ROM, a RAM, a flash memory, or the like) as a program that can be executed by a computer, and can be transmitted and distributed via a communication medium. The program stored in the medium includes a setting program that causes a software means executed by a computer (including not only an execution program but also a table or data structure) to be configured in the computer. A computer that implements the device executes the above-described process by reading the program recorded on the recording medium, constructing a software means according to the setting program in some cases, and operating under control of this software means. The recording medium referred to in the present specification is not limited to a recording medium for distribution, but includes a storage medium such as a magnetic disk or a semiconductor memory provided in a computer or a device connected via a network. The storage unit may function as, for example, a main storage device, an auxiliary storage device, or a cache memory.

### REFERENCE SIGNS LIST

100 Information processing system
200A Information processing terminal
200B Information processing terminal
300A NFC tag
300B NFC tag
400 Server device

1. An information processing system, comprising:
an information processing terminal;
a near field communication (NFC) tag and/or a two-dimensional barcode that stores uniform resource locator (URL) information regarding URL, of a server and installation position information regarding an installation position of the NFC tag and/or the two-dimensional barcode; and
the server on internet, wherein
the information processing terminal includes first circuitry configured to:
acquire the URL information and the installation position information by reading the NFC tag and/or the two-dimensional barcode, and
transmit terminal position information regarding a position of the information processing terminal and the acquired installation position information to the server based on the acquired URL information, and
the server includes second circuitry configured to:
determine whether or not the installation position of the NFC tag and/or the two-dimensional barcode and the position of the information processing terminal are within a predetermined distance based on the terminal position information and the installation position information transmitted from the information processing terminal, and
permit the information processing terminal to use a talk room service, in which the information processing terminal can communicate, via the server, with one or more other information processing terminals permitted to use the talk room service in response to determining that the installation position of the NFC tag and/or the two-dimensional barcode and the position of the information processing terminal are within the predetermined distance.

2. The information processing system according to claim 1, wherein the second circuitry is configured to manage the information processing terminal and the one or more other information processing terminals permitted to use the talk room service by reading the NFC tag and/or the two-dimensional barcode or another NFC tag and/or the two-dimensional barcode that stores another installation position information regarding another installation position having a predetermined relationship with the installation position of the NFC tag and/or the two-dimensional barcode, in association each other.

3. The information processing system according to claim 1, wherein when the server permits the information processing terminal to use the talk room service, the server sends requests to the one or more other information processing terminals to approve the information processing terminal to use the talk room service in a case where the one or more other information processing terminals have been already been permitted to use the talk room service.

4. The information processing system according to claim 3, wherein the server prohibits the information processing terminal to use the talk room service in a case where at least one of the one or more other information processing terminals does not approve the information processing terminal to use the talk room service in response to receiving the request.

5. The information processing system according to claim 1, wherein when the server permits the information processing terminal to use the talk room service, the server transmits information on one or more users of the one or more other information processing terminals to the information processing terminal and sends requests to the one or more other information processing terminals to approve the information processing terminal to use the talk room service in response to an operation to the information processing terminal in a case where the one or more other information processing terminals have already been permitted to use the talk room service.

6. The information processing system according to claim 1, wherein when the server permits the information processing terminal to use the talk room service, the server transmits information on one or more users of the one or more other information processing terminals to the information processing terminal and transmits an invitation to make a request for use of the talk room service to the one or more other information processing terminals in response to an operation to the information processing terminal in a case where the one or more other information processing terminals have not yet started to use the talk room service.

7. The information processing system according to claim 1, wherein user information regarding users of the information processing terminal and the one or more other information processing terminals, which the information processing terminal and the one or more other information processing terminals can unilaterally confirm from each other in the talk room service, is limited to icon images of the users.

8. The information processing system according to claim 1, wherein
the NFC tag is included in a sheet-like object that is able to be stuck to a target, and
the two-dimensional barcode including the URL information and the installation position information stored in the NFC tag is displayed on a surface of the sheet-like object.

9. The information processing system according to any one of claim 1, wherein
the NFC tag and/or the two-dimensional barcode is installed in an installation object associated with a user of the information processing terminal at a venue of a predetermined event,
the one or more other information processing terminals are permitted to use the talk room service, only during a predetermined time period, and
the predetermined time period is automatically set based on a holding time of the predetermined event.

10. The information processing system according to claim 9, wherein the server controls the information processing terminal to limit display, on the information processing terminal, of talk in the talk room service to text and a still image.

11. The information processing system according to claim 1, wherein
the NFC tag and/or the two-dimensional barcode is installed in an installation object associated with a user of the information processing terminal at a predetermined restaurant,
the one or more other information processing terminals are permitted to use the talk room service, only during a predetermined time period, and
the predetermined time period is automatically set based on an initial time when the server device has permitted the information processing terminal to use the talk room service.

12. The information processing system according to claim 11, wherein the server determines an advertisement to be displayed in the talk room service based on information of a user of the information processing terminal using the talk room service.

13. A server, comprising:
circuitry configured to
receive, from an information processing terminal, terminal position information regarding a position of the information processing terminal and installation position information regarding an installation position of a near field communication (NFC) tag and/or a two-dimensional barcode that stores uniform resource locator (URL) information regarding URL of the server and the installation position information, the URL information and the installation position information being acquired by the information processing terminal by reading the NFC tag and/or the two-dimensional barcode;
determine whether or not the installation position of the NFC tag and/or the two-dimensional barcode and the position of the information processing terminal are within a predetermined distance based on the terminal position information and the installation position information transmitted from the information processing terminal, and
permit the information processing terminal to use a talk room service, in which the information processing terminal can communicate, via the server, with one or more other information processing terminals permitted to use the talk room service, in response to determining that the installation position of the NFC tag and/or the two-dimensional barcode and the position of the information processing terminal are within the predetermined distance.

14. The server according to claim 13, wherein the circuitry is configured to manage the information processing terminal and the one or more other information processing terminals permitted to use the talk room service by reading the NFC tag and/or the two-dimensional barcode or another NFC tag and/or the two-dimensional barcode that stores another installation position information regarding another installation position having a predetermined relationship with the installation position of the NFC tag and/or the two-dimensional barcode, in association with each other.

15. The server according to claim 13, wherein when the server permits the information processing terminal to use the talk room service, the server sends requests to the one or more other information processing terminals to approve the information processing terminal to use the talk room service in a case where the one or more other information processing terminals have been already been permitted to use the talk room service.

16. The server according to claim 15, wherein the server prohibits the information processing terminal to use the talk room service in a case where at least one of the one or more other information processing terminals does not approve the information processing terminal to use the talk room service in response to receiving the request.

17. A non-transitory computer readable medium including executable instructions, which, when executed by a computer of a server, se the computer to execute a method comprising:
receiving, from an information processing terminal, terminal position information regarding a position of the information processing terminal and installation position information regarding an installation position of a near field communication (NFC) tag and/or a two-dimensional barcode that stores uniform resource locator (URL) information regarding URL of the server and the installation position information, the URL information and the installation position information being acquired by the information processing terminal by reading the NFC tag and/or the two-dimensional barcode;
determining whether or not the installation position of the NFC tag and/or the two-dimensional barcode and the position of the information processing terminal are within a predetermined distance based on the terminal position information and the installation position information transmitted from the information processing terminal, and
permitting the information processing terminal to use a talk room service, in which the information processing terminal can communicate, via the server, with one or more other information processing terminals permitted to use the talk room service, in response to determining that the installation position of the NFC tag and/or the two-dimensional barcode and the position of the information processing terminal are within the predetermined distance.

18. The non-transitory computer readable medium according to claim 17, wherein the method further comprise managing the information processing terminal and the one or more other information processing terminals permitted to use the talk room service by reading the NFC tag and/or the two-dimensional barcode or another NFC tag and/or the two-dimensional barcode that stores another installation position information regarding another installation position having a predetermined relationship with the installation position of the NFC tag and/or the two-dimensional barcode, in association with each other.

19. The non-transitory computer readable medium according to claim 17, wherein when the server permits the information processing terminal to use the talk room service, the executable instructions causes the computer of the server to send requests to the one or more other information processing terminals to approve the information processing terminal to use the talk room service in a case where the one or more other information processing terminals have been already been permitted to use the talk room service.

20. The non-transitory computer readable medium according to claim 19, wherein the method further comprises prohibiting the information processing terminal to use the talk room service in a case where at least one of the one or more other information processing terminals does not approve the information processing terminal to use the talk room service in response to receiving the request.
